(19) United States
(12) Patent Application Publication
(10) Pub. No.: US 2026/0236086 A1
(43) Pub. Date: Aug. 13, 2026

(54) MEMORY AND CPU MIGRATION FOR DATA CENTER COOLING

(71) Applicant: Hewlett Packard Enterprise Development LP, Spring, TX (US)

(72) Inventors: Kathryn M. Dahlgren, Ripon, CA (US); Michael A. Sevilla, San Diego, CA (US); Brian D. Moffet, Santa Cruz, CA (US); Michael A. Berman, Scotts Valley, CA (US)

(21) Appl. No.: 19/049,770

(22) Filed: Feb. 10, 2025

(51) Int. Cl. G06F 1/3296; G06F 11/07

(52) U.S. Cl. CPC G06F 1/3296; G06F 11/0721; G06F 11/076

(57) ABSTRACT

One aspect of the instant disclosure provides a system and method for energy management in a data center. During operation, the energy-management system may monitor performance associated with a plurality of servers running an application in a data center, identify one or more high-temperature servers among the plurality of servers based on the monitored performance, and identify one or more candidate replacement servers within the data center. In response to determining that a trigger condition is met by a high-temperature server, the energy-management system may replace the high-temperature server with a selected candidate replacement server by migrating, while the application is running, virtualized resources from the high-temperature server to the selected candidate replacement server and may place the high-temperature server in a low-power mode.

### BACKGROUND

### Field

This disclosure relates to a system and method for improving energy efficiency in data centers.

### Related Art

Data center power density has dramatically increased over the past decade, with racks and rows accommodating an ever-growing number of high-power servers in increasingly compact arrangements. This trend has led to immense power demands, with an estimated 3% of total energy consumption in the US currently dedicated to powering data centers. The vast majority of energy supplied to data center computing equipment is ultimately converted into heat. Mismanagement of this heat can have severe consequences, including diminished server performance, heightened risk of hardware and software failures, and accelerated equipment deterioration. Servers operating at high temperatures are more susceptible to soft and hard faults, which can negatively impact application speed and accuracy. Moreover, elevated temperatures can cause physical damage to system components, leading to an increased frequency of hard faults and a higher likelihood of hardware burnout.

### BRIEF DESCRIPTION OF THE FIGURES

FIG. 1 illustrates an example energy-management scenario in a data center, according to one aspect of the instant disclosure.

FIG. 2 illustrates the effect of replacing a high-temperature server with a candidate replacement server, according to one aspect of the instant disclosure.

FIG. 3 presents a flowchart illustrating an example process for detecting and replacing a high-temperature server, according to one aspect of the instant disclosure.

FIG. 4 illustrates an example computer system facilitating energy management in a data center, according to one aspect of the instant disclosure.

FIG. 5 illustrates a computer-readable medium (CRM) that facilitates energy management in a data center, according to one aspect of the instant disclosure.

In the figures, like reference numerals refer to the same figure elements.

### DETAILED DESCRIPTION

Effective heat management in data centers is crucial for maintaining optimal performance and reliability of the servers. In addition, it can reduce environmental impact and operational costs. Current data centers have employed various cooling infrastructures to prevent overheating, ranging from conventional industrial air conditioning systems to cutting-edge liquid cooling solutions. However, these approaches often address the symptoms rather than the root cause of the problem: energy efficiency.

One possible approach for improving energy efficiency in a data center involves timely moving computing loads from hotter servers to cooler servers to ensure that no server is overheated. For example, a server may be powered down or placed in an energy-efficient mode (e.g., sleep mode) before it becomes overheated. However, the inflexibility of contemporary computing architectures makes it difficult to maintain a balance between managing high equipment temperatures and avoiding potential disruption of active applications. This dilemma arises from the need to maintain application integrity, which often discourages system topology updates which is often needed to mitigate temperature hotspots.

According to some aspects of the instant disclosure, an energy-management system may efficiently manage the energy consumption within a data center by leveraging distributed hypervisor technology. Unlike traditional hypervisors that virtualize resources on a single physical server, a distributed hypervisor can bind a cluster of servers into a single-system image (i.e., forming a virtual machine). Such virtual machines, referred to as Software Defined Servers (SDSs), can offer unprecedented scalability and adaptability. The SDSs can be dynamically scaled up or down based on various factors such as price points, resource utilization, or workload demands. Crucially, this scaling can be performed without disrupting running applications, ensuring continuous operation. The SDS system is designed to maintain performance impacts within acceptable hardware latency margins, preserving overall system efficiency. An operating system running on the single-system image has access to the aggregate resources of the cluster of servers.

The energy-management system may monitor the temperature of servers in the data center to identify high-temperature servers and candidate replacement servers. A candidate replacement server may be an inactive server (e.g., a powered-off server or a server in sleep mode) physically positioned near the cooling infrastructure. In alternative examples, a server with a light load (e.g., a server with its CPU running at a capacity of 20% or less) may also be considered a candidate replacement server. When multiple candidate replacement servers are available, they may be ranked based on a plurality of factors (e.g., temperature or other related data, or distance to the cooling infrastructure). According to some aspects, when a predetermined trigger condition is met (e.g., the temperature of a server exceeds a threshold), the energy-management system may automatically initialize a server swap, which involves replacing the high-temperature server with the top-ranked candidate replacement server. More specifically, the energy-management system may migrate data, I/O, and CPUs from the high-temperature server to the top-ranked candidate replacement server, without interrupting applications running on the high-temperature server, and then power down the high-temperature server or place it in sleep mode. The energy-management system may be implemented on a separate server, e.g., a management server, and each server in the data center may be equipped with an administration port, through which health information (e.g., temperature data) associated with the server may be sent to the management server.

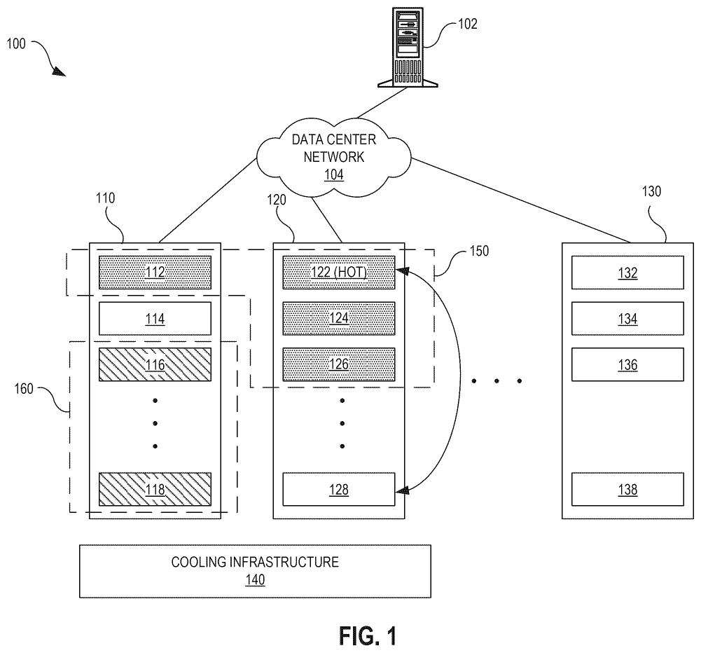

FIG. 1 illustrates an example energy-management scenario in a data center, according to one aspect of the instant disclosure. In the example shown in FIG. 1, a data center 100 may include a management server 102, a data center network 104, a plurality of server racks (e.g., server racks 110, 120, and 130), and a cooling infrastructure 140. Each server rack may include a plurality of servers coupled to management server 102 via data center network 104. For example, server rack 110 includes servers 112-118, server rack 120 includes servers 122-128, and server rack 130 includes servers 132-138.

Cooling infrastructure 140 may include a variety of cooling units, such as AC units that use fans to circulate air inside the data center and liquid cooling units that circulate coolant in contact with hot components. Depending on their physical location, the distance between each server and cooling infrastructure 140 may be different. In the example shown in FIG. 1, server racks 110 and 120 are positioned closer to cooling infrastructure 140 than server rack 130. Among all servers in server rack 110 or 120, the bottom servers (e.g., server 118 or 128) are closer to cooling infrastructure 140 than the top servers. Because the rate of heat dissipation depends on the temperature difference between a hot component and its surroundings, servers closer to cooling infrastructure 140 are often cooler or may cool down faster than faraway servers. Using server rack 110 as an example, bottom server 118 may cool down faster than top server 112. Similarly, servers on server rack 130 may be hotter than servers on server racks 110 and 120.

Multiple servers from different server racks may be bound by a distributed hypervisor controlled by management server 102 to form an SDS system. In the example shown in FIG. 1, servers 112, 122, 124, and 126 form an SDS system 150, and a subset of servers on rack 110 (e.g., servers 116 and 118) may form an SDS system 160. Data center 100 may include other SDS systems not shown in FIG. 1. A number of servers (e.g., servers 114, 128, and 132-138) in data center 100 are inactive (i.e., they may be placed in sleep mode or have been powered down).

Due to uneven cooling within the data center and different loads on each server, hotspots may be formed. In the example shown in FIG. 1, the temperature of server 122 may rise, causing server 122 to be prone to soft or hard faults. To prevent potential failures and to improve energy efficiency, management server 102 may select an inactive, low-temperature server to replace high-temperature or hot server 122. In the example shown in FIG. 1, data center 100 includes more than one inactive server. To effectively reduce the overall energy demands, management server 102 may choose server 128, which is closest to cooling infrastructure 140, to replace high-temperature server 122. Although replacing high-temperature server 122 with a different inactive server (e.g., server 114) may prevent overheating at server 122, it may not achieve the same energy-saving efficiency, because server 114 may be slightly warmer than server 128.

According to some aspects, replacing high-temperature server 122 with inactive, low-temperature server 128 may involve starting up server 128 and migrating virtualized resources (e.g., processors, I/O devices, processors, etc.) from high-temperature server 122 to low-temperature server 128. Applications running on SDS system 150 (which includes high-temperature server 122) may continue to run, without interruption, during the migration of the virtualized resources. More specifically, a distributed hypervisor for the particular SDS may be in charge of virtualizing and migrating the resources. After low-temperature server 128 is started up and the virtualized resources migrated, management server 102 may power off high-temperature server 122, thus reducing the overall or average temperature of SDS system 150.

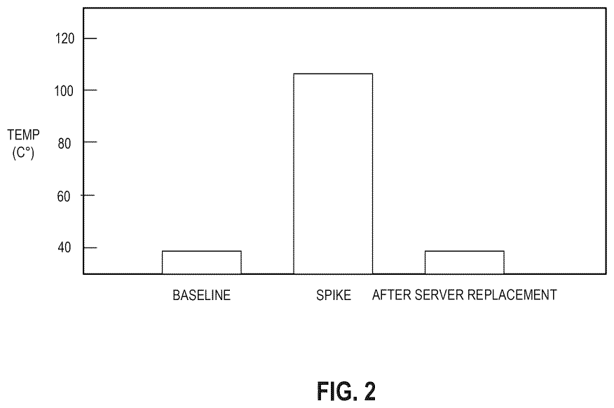

FIG. 2 illustrates the effect of replacing a high-temperature server with a candidate replacement server, according to one aspect of the instant disclosure. FIG. 2 shows that, before a temperature spike (which may result from increased workload or the failure of a fan), the baseline temperature of an SDS system is slightly below 40° C. (e.g., 37° C.). The SDS system may include multiple physical servers, and the temperature of the SDS system may be represented using the maximum CPU temperature of the multiple physical servers. FIG. 2 also shows that the temperature of the SDS system may rise above 100° C. during the temperature spike, which may automatically trigger the replacement of the high-temperature server. After the server replacement, the temperature of the SDS system may return to the baseline level. Hotter servers may require more energy used for cooling. Therefore, the prompt replacement of the high-temperature server may improve the energy efficiency of the data center.

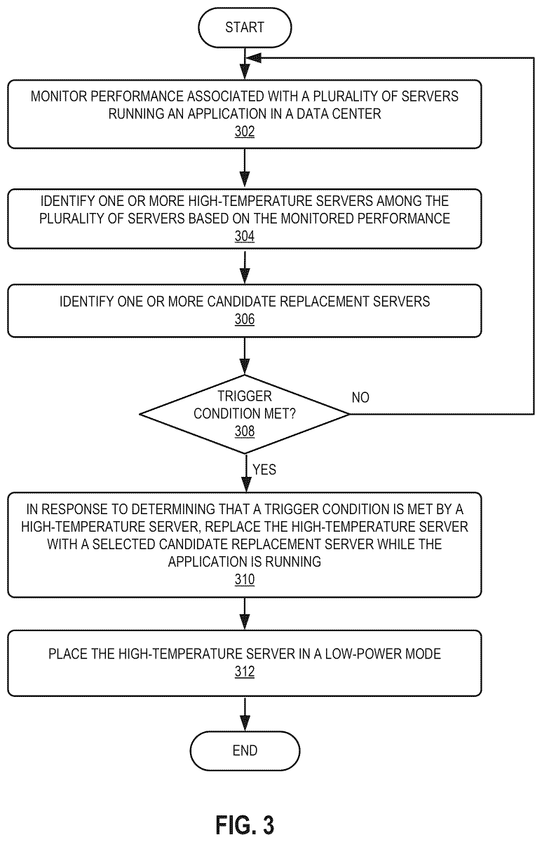

FIG. 3 presents a flowchart illustrating an example process for detecting and replacing a high-temperature server, according to one aspect of the instant disclosure. All or any portion of the operations shown in FIG. 3 may be performed, for example, by management server 102 shown in FIG. 1. Although the example process in FIG. 3 shows a specific order for performing certain operations, the process is not limited to such an order. Operations shown in succession in the flowchart may be performed in a different order and may be executed concurrently or with partial concurrence or combinations thereof.

During operation, an energy-management system may monitor the performance associated with a plurality of servers running an application in a data center (operation 302). According to some aspects, the plurality of servers may be bound by a distributed hypervisor to form an SDS system. The energy-management system may reside on a dedicated management server. Because the management server does not run customer applications, it is less likely to get hot and can continuously monitor the performance of the other servers. Each server in the data center may be equipped with a management port, and the energy-management system may collect telemetry data via the management port. In one example, the energy-management system may query the Baseboard Management Controller (BMC) on each server to actively collect critical hardware parameters, including CPU temperatures, fan speeds, and power consumption. Additional performance data, including but not limited to memory errors and network errors, may also be collected by the energy-management system. In alternative examples, the energy-management system may run an agent to passively collect telemetry data associated with the server performance, or run observability tools (e.g., a cloud-based observability tool like Amazon CloudWatch) to obtain performance data of the servers through associated application programming interfaces (APIs). In some examples, the BMC of a server may be up and running even after the server is powered down and can continue to provide server performance data to the energy-management system. In some examples, the BMC of a server may be powered down when the server is powered down, thus unable to provide live performance data. In such a situation, the energy-management system may obtain and store the performance data of the server for a predetermined time period before the server is powered off.

The energy-management system may identify one or more high-temperature servers among the plurality of servers based on the monitored performance (operation 304). According to some aspects, the energy-management system may identify the high-temperature servers based on the CPU temperature of each server. For example, the energy-management system may rank all servers in a data center or an SDS system based on their CPU temperatures. A number of top-ranked servers (e.g., the top 10% or 20%) may be identified as high-temperature servers. In alternative examples, servers with a CPU temperature higher than a predetermined threshold value may be identified as high-temperature servers. The predetermined threshold value may be 10% or 20% above the baseline (or average) CPU temperature of all servers in the data center or SDS system. The CPU temperature of a server may vary dynamically depending on the load of the CPU, and the predetermined temperature threshold may be configurable. Other environmental factors, such as faulty components or blocked vents, may also affect the CPU temperature of a server.

In addition to the CPU temperature, a server may be identified as a high-temperature server based on whether the temperature of other hardware components (e.g., fans, network interface controllers (NICs), or power supplies) within the server exceeds a configurable threshold (e.g., a maximum hardware temperature or a maximum temperature difference between specific hardware components across all servers in an SDS system. In one example, a server may be identified as a high-temperature server if the temperature of a particular hardware rises above a predetermined threshold. In an alternative example, a server may be identified as a high-temperature server if the temperature difference among hardware components within the server exceeds a predetermined threshold.

The energy-management system may identify one or more candidate replacement servers (operation 306). An ideal candidate replacement server may be an inactive server, such as a powered-off or idle server, physically close to a cooling unit. A server with a light load and physically close to the cooling unit may also be considered a candidate server. This requires the energy-management system to maintain certain knowledge about the topologies of the servers and cooling infrastructure in the data center. Servers close to the cooling infrastructure with light computing loads may also be considered candidate replacement servers. According to some aspects, the energy-management system may also rank the identified candidate replacement servers based on a number of factors, such as the distance to the cooling infrastructure, the current, past, or future CPU temperatures, etc.

Servers near the cooling infrastructure stay cooler and cool faster than other servers. Therefore, candidate servers closer to the cooling infrastructure may be ranked higher than candidate servers far away from the cooling infrastructure. In the example shown in FIG. 1, servers 114 and 128 are identified as candidate replacement servers, and server 128 has a higher ranking than server 114 because it is closer to cooling infrastructure 140.

In addition to the distance to the cooling infrastructure, the energy-management system may obtain temperature and other related data of the candidate replacement servers. In the event of a candidate server being powered off, the energy-management system may obtain historical temperature or other related data (e.g., the average CPU temperature, fan speed, or memory/network errors) for a predetermined period before the candidate server is powered off) and rank the candidate server based on the historical temperature and other related data. In one example, a candidate server may be ranked based on the last recorded temperature before it is powered down. For example, two candidate replacement servers may be in close vicinity of each other (meaning that they have a similar distance to the cooling infrastructure) and may both be powered off (meaning that no current temperature or other related data is available). To rank these two servers, the energy-management system may look up historical temperature and other related data associated with these powered-off servers. More specifically, the server with a lower temperature at the time of powering off will be ranked higher.

To avoid thrashing (e.g., replacing a failing server and then unintentionally re-incorporating it at a later time without addressing the failing conditions), the energy-management system may prefer replacement servers that have not been used recently (at least within the same SDS) and prohibit the use of a previously identified high-temperature server until one or more certain predetermined conditions have been met (e.g., a diagnostic test has been performed on the server or the server has been cleared for use by the data center administrator).

According to some aspects, the energy-management system may apply a machine learning technique to predict future CPU temperatures of candidate replacement servers and then rank the candidate replacement servers based on the predicted temperatures. In some examples, the energy-management system may predict the future temperature of a server based on the application running in the SDS. More specifically, the energy-management system may use a machine learning model (e.g., a deep-learning neural network) to predict the potential computation load to be migrated to the server and to predict temperature accordingly. According to further aspects, a pre-trained machine learning model may be used to predict the overall or average temperatures of the SDS system after replacing the high-temperature server with different replacement servers. The energy-management system may select a candidate server that can result in the lowest temperature of the SDS system. In another example, machine learning techniques may be used to learn healthy vs. unhealthy statistic patterns to identify current low-temperature servers that are likely to run reliably in the near future without requiring replacement.

Ranking the candidate replacement servers may also involve combining the temperature and the distance-to-cooling-infrastructure information in a weighted fashion. Depending on the design, the energy-management system may apply different weight factors to the temperature and the distance to the cooling infrastructure. In one example, a larger weight may be assigned to the temperature, where the energy-management system may rank a server with a lower temperature but further away from the cooling infrastructure higher than a server with a higher temperature but closer to the cooling infrastructure. In a different example, a larger weight may be assigned to the distance to the cooling infrastructure, where the energy-management system may rank a hotter server closer to the cooling infrastructure higher than a colder server further away from the cooling infrastructure.

The energy-management system then determines whether a trigger condition is met by a high-temperature server based on the performance monitoring of servers in the data center (operation 308). According to some aspects, the trigger condition may be the physical parameters associated with a hardware component (e.g., CPU, fan, NIC, power supply, etc.) within the high-temperature server falling outside of a predetermined threshold range. In one example, the trigger condition may be the maximum CPU temperature. Note that high CPU temperature may indicate that the server is too hot and likely to fail in the near future. In another example, the trigger condition may be the fan speed exceeds a predetermined range. A fan speed below the lower bound of the predetermined range may indicate a failing fan, especially if the CPU is disproportionately hot. A fan speed above the higher bound of the predetermined range may also indicate a failing fan, especially when the CPU temperature is disproportionately low.

In alternative aspects, the trigger condition may be the difference in certain physical parameters (e.g., CPU temperature or fan speed) among the servers within an SDS system exceeding a predetermined maximum allowable range. Such a range may be considered as a “normal” parameter range for the SDS. Servers with abnormal parameters may trigger replacement. In addition, a difference in temperature among hardware components within a particular high-temperature server exceeding a predetermined threshold (which may be an absolute value or a percentage) may also trigger replacement of that server. For example, the trigger condition may be met if the temperature difference between the CPU and the fan exceeds the predetermined threshold. Additional trigger conditions may be defined based on the server performance, such as the memory or network error rate exceeding a predetermined threshold. A high error rate may indicate a poorly performing server, due to either software or hardware issues, which may lead to waste of energy.

In response to determining that a trigger condition is met by a high-temperature server, the energy-management system may replace the high-temperature server with a selected candidate replacement server while the application is running (operation 310). In one example, the trigger condition is met when the monitored temperature of one or more high-temperature server exceeds a predetermined threshold. In another example, the trigger condition is met when the monitored fan speed of one or more high-temperature server exceeds a predetermined range. In yet another example, the trigger condition is met when the memory or network error rate of one or more high-temperature server exceeds a predetermined threshold.

According to some aspects, the energy-management system may select the highest-ranked candidate replacement server to replace the high-temperature server meeting the trigger condition. In one example, the energy-management system may select an inactive server (e.g., a powered-down server or a server placed in sleep mode) that is closest to the cooling infrastructure (e.g., a vent of the AC unit or a pipe of the liquid-cooling unit) to replace the high-temperature server. In another example, the energy-management system may select an inactive server with the lowest temperature to replace the high-temperature server. When multiple servers meet the trigger condition, the energy-management system may replace the hottest server first. The order of replacement may be determined based on the current and/or the predicted future CPU temperature of the high-temperature servers.

Replacing a high-temperature server may include migrating virtualized resources from the high-temperature server to the selected candidate replacement server. The virtualized resources may include processing resources, I/O resources, memory resources, etc. According to some aspects, to replace the high-temperature server, the energy-management system may start up the selected candidate replacement server (which may be powered off or in sleep mode) and notify other servers in the same SDS system of the presence of the replacement server.

The outgoing high-temperature server may also send notifications to other servers in the same SDS system, indicating it is being replaced. In one aspect, the outgoing server may broadcast a message to all servers in the SDS system. In response, the other servers stop sending requests and resources to the outgoing server, allowing resources to leave the outgoing server with none returning. As a result, the resources will drain from the outgoing server.

The outgoing high-temperature server may then send the resources to the replacement server. It may first send a map of where to find the resources, then devices (e.g., interrupt controllers, storage devices, universal asynchronous receiver-transmitter (UART), etc.), and finally pages of memory. The number of pages that migrate depends on the workload; jobs that dirty (i.e., modify) fewer pages need to migrate fewer pages.

Once powered up, the replacement server may function as part of the SDS system. While the outgoing server migrates devices and pages, the replacement server may service requests and look up the resource map when needed. The replacement server may also request resources or forward requests for resources yet to be migrated from the outgoing server, thus facilitating continuous execution of the application by the SDS system.

Upon the completion of migrating resources from the high-temperature server to the replacement server, the energy-management system may place the high-temperature server in a low-power state (operation 312). In some examples, the high-temperature server may be powered down. Powering down the high-temperature server reduces the overall temperature of the SDS system and, hence, the energy needs. In some examples, the energy-management system may place the high-temperature server in sleep mode. In alternative examples, the energy-management system may choose to migrate a portion of the loads from the high-temperature server to the replacement server, thus allowing the high-temperature server to run a lighter-load. Reducing the load of the high-temperature server may effectively reduce its temperature, given that no hardware failure occurs on the server.

In some examples, the highest-ranked candidate replacement server may include a lightly loaded server close to the cooling infrastructure. In such cases, replacing the high-temperature server may involve first migrating resources from the lightly loaded server to an available inactive server (which may be a server far away from the cooling infrastructure), thus vacating the lightly loaded server. The energy-management server may then migrate resources from the high-temperature server to the vacated server.

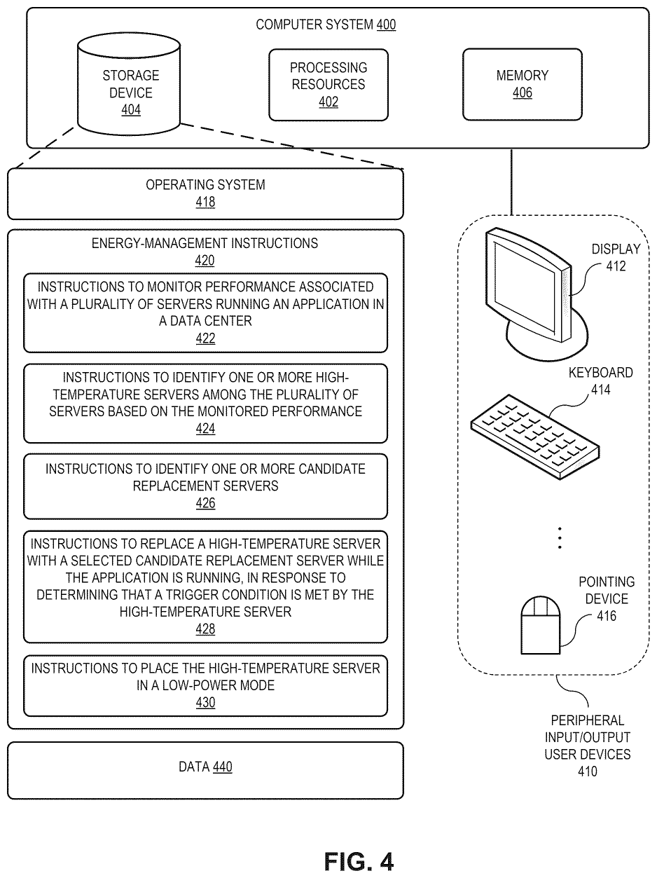

FIG. 4 illustrates an example computer system facilitating energy management in a data center, according to one aspect of the instant disclosure. Computer system 400 may include one or more processing resources (e.g., a processing resource 402), one or more storage devices (e.g., storage device 404), and a memory 406.

A processing resource may include, for example, one processor or multiple processors included in a single computing device or distributed across multiple computing devices. In some examples, the concurrent processes may be executed on a single computing device or multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Computer system 400 can be coupled to peripheral I/O user devices 410 (e.g., a display device 412, a keyboard 414, and a pointing device 416). Storage device 404 includes a non-transitory computer-readable storage medium and stores an operating system 418, energy-management instructions 420, and data 440. Computer system 400 may include fewer or more entities than those shown in FIG. 4. According to some aspects, computer system 400 may be implemented by a dedicated management server (e.g., management server 102 shown in FIG. 1) within a data center.

Energy-management instructions 420 may include instructions, which when executed by computer system 400, can cause computer system 400 to perform methods and/or processes described in this disclosure. Energy-management instructions 420 can be executed at least on processing resource 402.

Energy-management instructions 420 may include instructions 422 to monitor the performance associated with a plurality of servers running an application in a data center, as described above in relation to operation 302 shown in FIG. 3. The plurality of servers may be bound by a distributed hypervisor to form an SDS system. Instructions 422 may include instructions to communicate with the BMC of each server to actively collect health data, such as the temperature of various hardware components, fan speed, power supply voltage, memory errors, network errors, etc. Instructions 422 may also include instructions to run an agent to passively collect health data (e.g., temperature or other related data) associated with the servers.

Energy-management instructions 420 may include instructions 424 to identify one or more high-temperature servers among the plurality of servers based on the monitored performance, as described above in relation to operation 304 shown in FIG. 3. Servers may be identified as high-temperature servers based on CPU temperatures or temperature variation among hardware components.

Energy-management instructions 420 may include instructions 426 to identify one or more candidate replacement servers, as described above in relation to operation 306 shown in FIG. 3. Instructions 426 may identify a number of inactive servers, including powered-off or idle servers, as candidate replacement servers. Instructions 426 may additionally identify one or more servers with a light load as candidate replacement servers. Instructions 426 may also include instructions to rank the candidate replacement servers based on their distance to the cooling infrastructure and/or temperature and/or other related data associated with these servers (e.g., CPU or hardware temperatures).

Energy-management instructions 420 may include instructions 428 to replace a high-temperature server with a selected candidate replacement server while the application is running, in response to determining that a trigger condition is met by the high-temperature server, as described above in relation to operation 308 shown in FIG. 3. The trigger condition may be the temperature associated with a hardware component within the high-temperature server exceeding a predetermined threshold or a difference in temperature among components within the high-temperature server exceeding a predetermined threshold. Instructions 428 may include instructions to select the highest-ranked candidate replacement server, e.g., a server closest to the cooling infrastructure or a server with the lowest temperature.

Energy-management instructions 420 may include instructions 430 to place the high-temperature server in a low-power mode after resources have been migrated from the high-temperature server to the selected candidate replacement server, as described above in relation to operation 310 shown in FIG. 3. Alternatively, instructions 430 may include instructions to place the high-temperature server in sleep mode.

Energy-management instructions 420 may include more instructions than those shown in FIG. 4. For example, energy-management instructions 420 may include instructions to look up historical temperature and other related data of powered-off servers and instructions to apply a machine learning technique to predict future temperatures of candidate replacement servers.

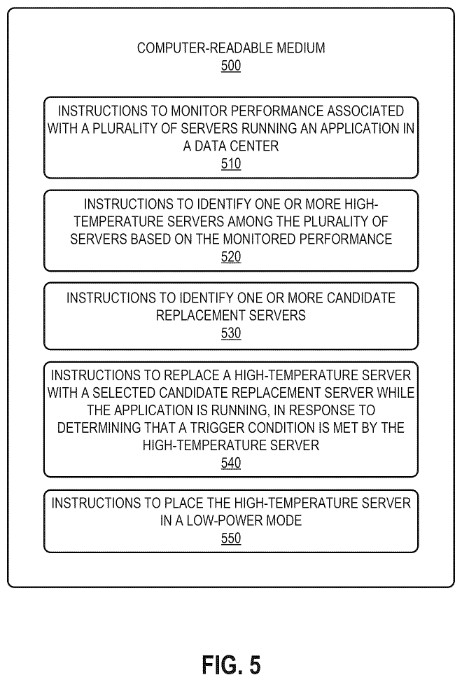

FIG. 5 illustrates a computer-readable medium (CRM) that facilitates energy management in a data center, according to one aspect of the instant disclosure. CRM 500 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 500 may store instructions 510 to monitor the performance associated with a plurality of servers running an application in a data center, as described above in relation to operation 302 shown in FIG. 3; instructions 520 to identify one or more high-temperature servers among the plurality of servers based on the monitored performance, as described above in relation to operation 304 shown in FIG. 3; instructions 530 to identify one or more candidate replacement servers, as described above in relation to operation 306 shown in FIG. 3; instructions 540 to replace a high-temperature server with a selected candidate replacement server while the application is running, in response to determining that a trigger condition is met by the high-temperature server, as described above in relation to operation 308 shown in FIG. 3; and instructions 550 to place the high-temperature server in a low-power mode, as described above in relation to operation 310 shown in FIG. 3.

CRM 500 may include more instructions than those shown in FIG. 5. For example, CRM 500 may include instructions to look up historical temperature and other related data of powered-off servers and instructions to apply a machine learning technique to predict future temperatures of candidate replacement servers.

In general, aspects of the disclosure provide an energy-management system in a data center that can reduce energy consumed by servers without disrupting running applications. A dedicated management server may implement an energy-management system that can continuously monitor the performance of servers running an application in a data center to identify a number of high-temperature servers and a number of candidate replacement servers. The energy-management system may also rank the candidate replacement servers based on a plurality of factors (e.g., distance to a cooling unit, temperature data, or other related data). In response to a high-temperature server meeting a trigger condition, the energy-management system may automatically replace the high-temperature server with the top-ranked candidate replacement server without interrupting the running application.

The disclosure includes examples of using machine learning techniques to select and/or rank candidate replacement servers. In practice, other types of Artificial Intelligence (AI) techniques may also be implemented. As used herein, the term “machine learning” may refer to one of many AI techniques in which the control and automation software layers utilize a machine learning, autonomous agent, or other AI techniques to optimize data center temperatures without direct human intervention.

One aspect of the instant disclosure provides a system and method for energy management in a data center. During operation, the energy-management system may monitor performance associated with a plurality of servers running an application in a data center, identify one or more high-temperature servers among the plurality of servers based on the monitored performance, and identify one or more candidate replacement servers within the data center. In response to determining that a trigger condition is met by a high-temperature server, the energy-management system may replace the high-temperature server with a selected candidate replacement server by migrating, while the application is running, virtualized resources from the high-temperature server to the selected candidate replacement server and may place the high-temperature server in a low-power mode.

In a variation on this aspect, the trigger condition may include one or more: a temperature associated with a hardware component within the high-temperature server exceeding a predetermined threshold; a difference in temperature among components within the high-temperature server exceeding a predetermined threshold; a difference in one or more physical parameters among servers within a virtual server system comprising the high-temperature server exceeding a predetermined threshold; or an error rate associated with the high-temperature server exceeding a predetermined threshold.

In a variation on this aspect, monitoring the performance may include one or more: querying a baseboard management controller (BMC) on each server to actively collect temperature and/or other related data; running an agent to passively collect the temperature and/or other related data from each server; or implementing an observability tool.

In a variation on this aspect, the candidate replacement servers may include powered-off servers, servers in sleep mode, or servers running lighter workloads.

In a further variation, identifying the one or more candidate replacement servers may include looking up historical temperature and/or other related data associated with the powered-off servers.

In a variation on this aspect, the energy-management system may rank the identified candidate replacement servers and select the highest-ranked candidate replacement server to replace the high-temperature server. Ranking the identified candidate replacement servers may be based on one or more of: a distance between a respective candidate replacement server to a cooling infrastructure within the data center; and a current, historical, or future temperature and/or other related data associated with the respective candidate replacement server.

In a further variation, the energy-management system may apply a machine learning technique to predict the future temperature and/or other related data associated with the respective candidate replacement server.

One aspect of the instant disclosure provides a computer system, which may include a processing resource and a non-transitory machine-readable storage medium comprising instructions executable by the processing resource to: monitor performance associated with a plurality of servers running an application in a data center; identify one or more high-temperature servers among the plurality of servers based on the monitored performance; identify one or more candidate replacement servers within the data center; in response to determining that a trigger condition is met by a high-temperature server, replace the high-temperature server with a selected candidate replacement server by migrating, while the application is running, virtualized resources from the high-temperature server to the selected candidate replacement server; and place the high-temperature server in a low-power mode.

One aspect of the instant disclosure provides a non-transitory computer-readable storage medium storing instructions to: monitor performance associated with a plurality of servers running an application in a data center; identify one or more high-temperature servers among the plurality of servers based on the monitored performance; identify one or more candidate replacement servers within the data center; in response to determining that a trigger condition is met by a high-temperature server, replace the high-temperature server with a selected candidate replacement server by migrating, while the application is running, virtualized resources from the high-temperature server to the selected candidate replacement server; and place the high-temperature server in a low-power mode.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
monitoring, by a computer, performance associated with a plurality of servers running an application in a data center;
identifying one or more high-temperature servers among the plurality of servers based on the monitored performance;
identifying one or more candidate replacement servers within the data center;
in response to determining that a trigger condition is met by a high-temperature server, replacing the high-temperature server with a selected candidate replacement server by migrating, while the application is running, virtualized resources from the high-temperature server to the selected candidate replacement server; and
place the high-temperature server in a low-power mode.

2. The method of claim 1, wherein the trigger condition comprises one or more:
a temperature associated with a hardware component within the high-temperature server exceeding a predetermined threshold;
a difference in temperature among components within the high-temperature server exceeding a predetermined threshold;
a difference in one or more physical parameters among servers within a virtual server system comprising the high-temperature server exceeding a predetermined threshold; or
an error rate associated with the high-temperature server exceeding a predetermined threshold.

3. The method of claim 1, wherein monitoring the performance comprises one or more:
querying a baseboard management controller (BMC) on each server to actively collect temperature and/or other related data;
running an agent to passively collect the temperature and/or other related data from each server; or
running an observability tool.

4. The method of claim 1, wherein the candidate replacement servers comprise powered-off servers, servers in sleep mode, or servers running lighter workloads.

5. The method of claim 4, wherein identifying the one or more candidate replacement servers comprises looking up historical temperature and/or other related data associated with potential candidate replacement servers.

6. The method of claim 1, further comprising ranking the identified candidate replacement servers and selecting a highest-ranked candidate replacement server to replace the high-temperature server, wherein ranking the identified candidate replacement servers is based on one or more of:
a distance between a respective candidate replacement server to a cooling infrastructure within the data center; and
a current, historical, or future temperature and/or other related data associated with the respective candidate replacement server.

7. The method of claim 6, further comprising applying a machine learning technique to predict the future temperature and/or other related data associated with the respective candidate replacement server.

8. A computer system, comprising:
a processing resource; and
a non-transitory machine-readable storage medium comprising instructions executable by the processing resource to:
monitor performance associated with a plurality of servers running an application in a data center;
identify one or more high-temperature servers among the plurality of servers based on the monitored performance;
identify one or more candidate replacement servers within the data center;
in response to determining that a trigger condition is met by a high-temperature server, replace the high-temperature server with a selected candidate replacement server by migrating, while the application is running, virtualized resources from the high-temperature server to the selected candidate replacement server; and
place the high-temperature server in a low-power mode.

9. The computer system of claim 8, wherein the trigger condition comprises one or more:
a temperature associated with a hardware component within the high-temperature server exceeding a predetermined threshold;
a difference in temperature among components within the high-temperature server exceeding a predetermined threshold;
a difference in one or more physical parameters among servers within a virtual server system comprising the high-temperature server exceeding a predetermined threshold; or
an error rate associated with the high-temperature server exceeding a predetermined threshold.

10. The computer system of claim 8, wherein monitoring the performance comprises one or more:
querying a baseboard management controller (BMC) on each server to actively collect temperature and/or other related data;
running an agent to passively collect the temperature and/or other related data from each server; or
running an observability tool.

11. The computer system of claim 8, wherein the candidate replacement servers comprise powered-off servers, servers in sleep mode, or servers running lighter workloads.

12. The computer system of claim 11, wherein identifying the one or more candidate replacement servers comprises looking up historical temperature and/or other related data associated with potential candidate replacement servers.

13. The computer system of claim 8, wherein the processing resource is further to rank the identified candidate replacement servers and select a highest-ranked candidate replacement server to replace the high-temperature server, wherein ranking the identified candidate replacement servers is based on one or more of:
a distance between a respective candidate replacement server to a cooling infrastructure within the data center; and
a current, historical, or future temperature associated with the respective candidate replacement server.

14. The computer system of claim 13, wherein the processing resource is further to apply a machine learning technique to predict the future temperature associated with the respective candidate replacement server.

15. A non-transitory computer-readable storage medium storing instructions to:
monitor performance associated with a plurality of servers running an application in a data center;
identify one or more high-temperature servers among the plurality of servers based on the monitored performance;
identify one or more candidate replacement servers within the data center;
in response to determining that a trigger condition is met by a high-temperature server, replace the high-temperature server with a selected candidate replacement server by migrating, while the application is running, virtualized resources from the high-temperature server to the selected candidate replacement server; and
place the high-temperature server in a low-power mode.

16. The non-transitory computer-readable storage medium of claim 15, wherein the trigger condition comprises one or more:
a temperature associated with a hardware component within the high-temperature server exceeding a predetermined threshold;
a difference in temperature among components within the high-temperature server exceeding a predetermined threshold;
a difference in one or more physical parameters among servers within a virtual server system comprising the high-temperature server exceeding a predetermined threshold; or
an error rate associated with the high-temperature server exceeding a predetermined threshold.

17. The non-transitory computer-readable storage medium of claim 15, wherein monitoring the performance comprises one or more:
querying a baseboard management controller (BMC) on each server to actively collect temperature and/or other related data;
running an agent to passively collect the temperature and/or other related data from each server; or
running an observability tool.

18. The non-transitory computer-readable storage medium of claim 15, wherein the candidate replacement servers comprise powered-off servers or servers in sleep mode, and wherein identifying the one or more candidate replacement servers comprises looking up historical temperature and/or other related data associated with potential candidate replacement servers.

19. The non-transitory computer-readable storage medium of claim 15, wherein the instructions are further to rank the identified candidate replacement servers and select a highest ranked candidate replacement server to replace the high-temperature server, wherein ranking the identified candidate replacement servers is based on one or more of:
a distance between a respective candidate replacement server to a cooling infrastructure within the data center; and
a current, historical, or future temperature and/or other related data associated with the respective candidate replacement server.

20. The non-transitory computer-readable storage medium of claim 19, wherein the instructions are further to apply a machine learning technique to predict the future temperature and/or other related data associated with the respective candidate replacement server.
